(19) United States
(12) Patent Application Publication
(10) Pub. No.: US 2010/0150576 A1
(43) Pub. Date: Jun. 17, 2010

(54) OPTICAL TRANSMITTING APPARATUS FOR RETURN-TO-ZERO DIFFERENTIAL PHASE-SHIFT-KEYING (RZ-DPSK) OR RETURN-TO-ZERO DIFFERENTIAL QUADRATURE PHASE SHIFT KEYING (RZ-DQPSK)

(76) Inventors: Hwan-seok Chung, Daejeon-si (KR); Sun-hyok Chang, Daejeon-si (KR); Kwang-joon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/610,985

(22) Filed: Nov. 2, 2009

(30) Foreign Application Priority Data
Dec. 12, 2008 (KR) 10-2008-0126738
Mar. 30, 2009 (KR) 10-2009-0027026

(51) Int. Cl. H04B 10/04

(52) U.S. Cl. 398/188

(57) ABSTRACT

An optical transmitting apparatus is disclosed. The optical transmitting apparatus outputs a signal having the same phase characteristics as a Return-to-Zero Differential Phase-Shift-Keying (RZ-DPSK) signal by using a single phase modulator. Accordingly, it is possible to generate RZ-DPSK signals without using a separate RZ modulator.

### CROSS-REFERENCE TO RELATED APPLICATION

This application claims the benefit under 35 U.S.C. §119(a) of Korean Patent Applications No. 10-2008-126738, filed on Dec. 12, 2008 and No. 10-2009-27026, filed on Mar. 30, 2009, the disclosures of which are incorporated by reference in its entirety for all purposes.

### BACKGROUND

1. Field

The following description relates to an optical transmitting apparatus suitable for transmitting ultrafast optical signals, and more particularly, to an optical transmitting apparatus based on phase shift keying (PSK).

2. Description of the Related Art

Internet traffic is increasing day by day. In particular, following the popularization of Internet TV and Ethernet-based services such as User Created Contents (UCCs), traffic is rapidly increasing and a wide area network is becoming more and more essential. Due to this trend, a wavelength division multiplexing (WDM) optical transmitting system which multiplexes a plurality of wavelengths in a single optical fiber is being considered as a means capable of most efficiently handling excess traffic. In order to support the WDM optical transmitting system, various modulation methods for high-speed channels have been introduced in addition to increasing a transfer bit rate per wavelength (per channel).

In order to fulfill bandwidth requirements in equipment where heavy data traffic occurs, such as a high-performance computer, a server, a data sensor, an enterprise network, an Internet exchange center, etc., signals capable of being transmitted at a transfer rate of 40 or more Gigabits per wavelength are appearing. Along with this, in order to transfer such high-speed signals, Differential Phase Shift Keying (DPSK) modulation capable of modulating the phases of optical signals or Differential Phase Quaternary Shift Keying (DPQSK) modulation capable of transmitting 2 or more bits for each symbol, instead of Non-Return-to-Zero (NRZ) or Return-to-Zero (RZ) modulation which simply controls the magnitudes of optical signals, have been introduced. The DPSK and DPQSK modulations have an advantage that they can overcome limitations of optical/electrical devices in a high-speed optical transmission system and reduce various constraints on optical lines.

### SUMMARY

The following description relates to an optical transmitting apparatus capable of generating Return-to-Zero Differential Phase-Shift-Keying (RZ-DPSK) or Return-to-Zero Differential Quadrature Phase Shift Keying (RZ-DQPSK) signals without use of a RZ modulator.

According to an exemplary aspect, there is provided an optical transmitting apparatus outputting a signal having the same phase characteristics as a Return-to-Zero Differential Phase-Shift-Keying (RZ-DPSK) signal by using a single phase modulator. The optical transmitting apparatus further includes: a mixer to output a driving data signal by receiving a data signal from a precoder and a clock signal having a frequency which is half a frequency of the data signal and mixing the data signal with the clock signal; and a phase modulator to modulate an optical signal output from an optical source using the driving data signal.

According to an exemplary aspect, there is provided an optical transmitting apparatus outputting a signal having the same phase characteristics as a Return-to-Zero Differential Phase-Shift-Keying (RZ-DPSK) signal by using two phase modulators connected in parallel. The optical transmitting apparatus includes: a first mixer to output a first driving data signal by mixing a first data signal generated by a precoder with a clock signal having a frequency which is half a frequency of the first data signal; a second mixer to output a second driving data signal by mixing a second data signal generated by the precoder with a clock signal having a frequency which is half a frequency of the second data signal; and a phase modulator including a first phase modulator to modulate an optical signal of an optical source using the first driving data signal output from the first mixer, and a second phase modulator to modulate an optical signal of the optical source using the second driving data signal output from the second mixer.

Accordingly, since the optical transmitting apparatus generates RZ-DPSK or RZ-DQPSK signals without use of a RZ modulator, the optical transmitting apparatus can have a compact structure with low optical loss while being capable of being manufactured at low cost. Also, the optical transmitting apparatus can easily amplify signals as it can be formed to only use a narrow-band RF amplifier. In addition, since control on bias factors is achieved by only measuring the amplitude of a frequency of a data signal, a bias control circuit can be easily configured without having to install any other circuit for applying separate frequencies.

Other objects, features and advantages will be apparent from the following description, the drawings, and the claims.

### BRIEF DESCRIPTION OF THE DRAWINGS

FIG. 1 illustrates a configuration of a conventional Differential Phase-Shift-Keying (DPSK) optical transmitting apparatus.

FIG. 2 is a view for explaining a general concept by which a DPSK signal is generated.

FIG. 3 is a view for explaining a general concept by which a Return-to-Zero Differential Phase-Shift-Keying (RZ-DPSK) signal is generated.

FIG. 4 illustrates a configuration of a conventional Return-to-Zero Differential Quadrature Phase Shift Keying (RZ-DQPSK) optical transmitting apparatus.

FIG. 5 illustrates a configuration of a RZ-DPSK optical transmitting apparatus according to an exemplary embodiment.

FIG. 6 is a view for explaining a method of generating a driving data signal illustrated in FIG. 5, according to an exemplary embodiment.

FIG. 7 is a view for explaining a method of applying the driving data signal, according to an exemplary embodiment.

FIG. 8 illustrates a configuration of a RZ-DQPSK optical transmitting apparatus according to an exemplary embodiment.

FIG. 9 shows an eye-diagram and constellation diagram of a RZ-DQPSK signal output from the RZ-DQPSK optical transmitting apparatus.

FIG. 10 is a graph showing changes in RF power with respect to a bias value.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

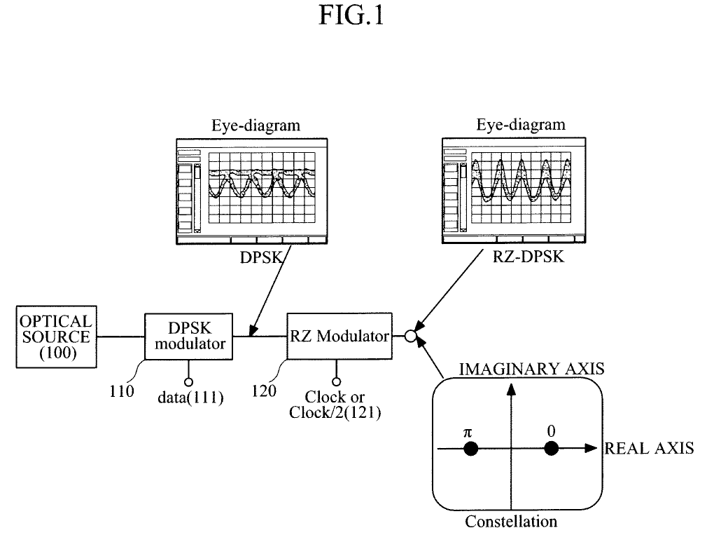

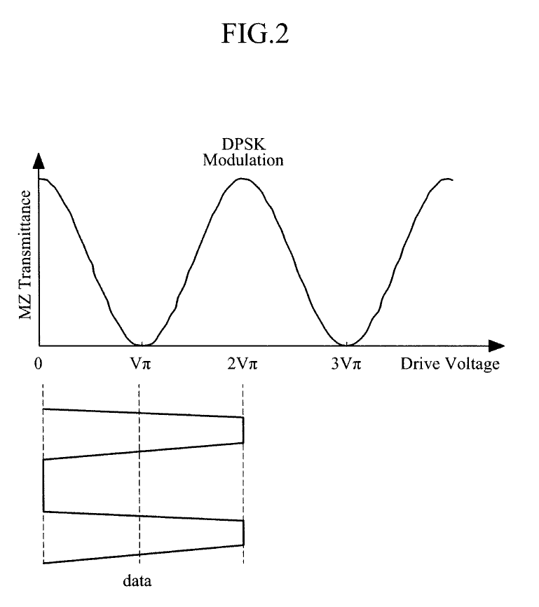

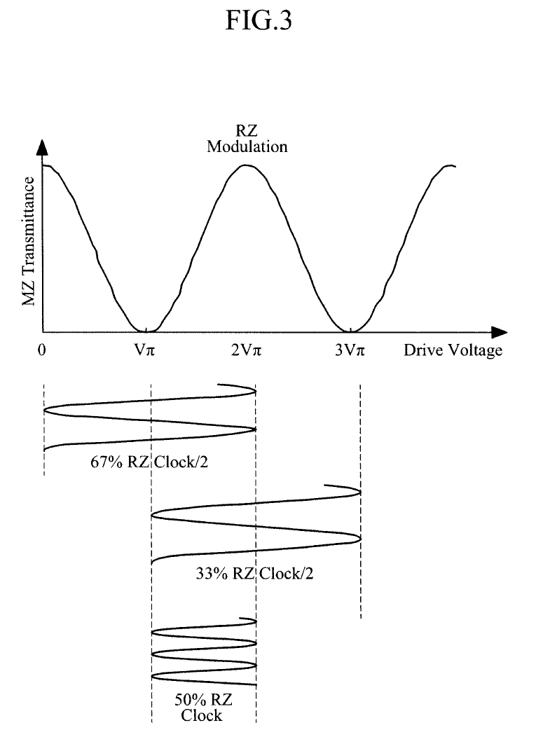

FIG. 1 illustrates a configuration of a conventional Differential Phase-Shift-Keying (DPSK) optical transmitting apparatus, FIG. 2 is a view for explaining a general concept by which a DPSK signal is generated, and FIG. 3 is a view for explaining a general concept by which a Return-to-Zero Differential Phase-Shift-Keying (RZ-DPSK) signal is generated

Referring to FIG. 1, the DPSK optical transmitting apparatus include an optical source 100, a DPSK modulator 110 and a RZ modulator 120. The optical source 100, which outputs optical signals, may be a laser diode (LD). The DPSK modulator 110 modulates an optical signal received from the optical source 100. The DPSK modulator 111 may be a Mach-Zehnder (MZ) modulator. The DPSK modulator 110 receives electrical data 111 generated by a precoder and modulates the phase of the received optical signal to 0 or π according to the electrical data 111. As illustrated in FIG. 2, if electrical data 111 is applied to the DPSK modulator 110 with the electrical data signal 111 having a 2Vπ width which corresponds to one period of a transfer curve that is the output of the DPSK modulator 110 in the state where a bias is placed at a lowest point on the transfer curve, a DPSK eye-diagram illustrated in FIG. 1 can be obtained.

In this case, when the DPSK modulator 110 is connected in series to the RZ modulator 120, the DPSK optical transmitting apparatus is less influenced by the patterns of optical/electrical devices used to generate DPSK signals and the performance of the DPSK optical transmitting apparatus can be maintained constant with lower SNR than that of DPSK signals. Referring to FIG. 3, by selectively using a method of placing a bias of a clock signal 121 at the lowest point on the transfer curve and using a frequency which is half a transfer bit rate and a method of placing a bias of a clock signal 121 at the middle point of the transfer curve and using the same frequency as the transfer bit rate, the duty cycle can be adjusted. Accordingly, the RZ-DPSK output appears in the pattern of a sine-wave signal and has values of 0 and π on a phase plane. Although RZ-DPSK signals have the above-described advantages, use of two MZ modulators inevitably increases optical loss. In addition, a separate optical/electrical device for optical synchronization of a DPSK modulator with a RZ modulator is needed, which makes the structure of the RZ-DPSK optical transmitting apparatus complicated. Furthermore, in order to amplify the magnitude of electrical data which is applied to the MZ modulator, required is an RF amplifier having a wide frequency range which ranges from DC to a frequency of a transfer bit rate.

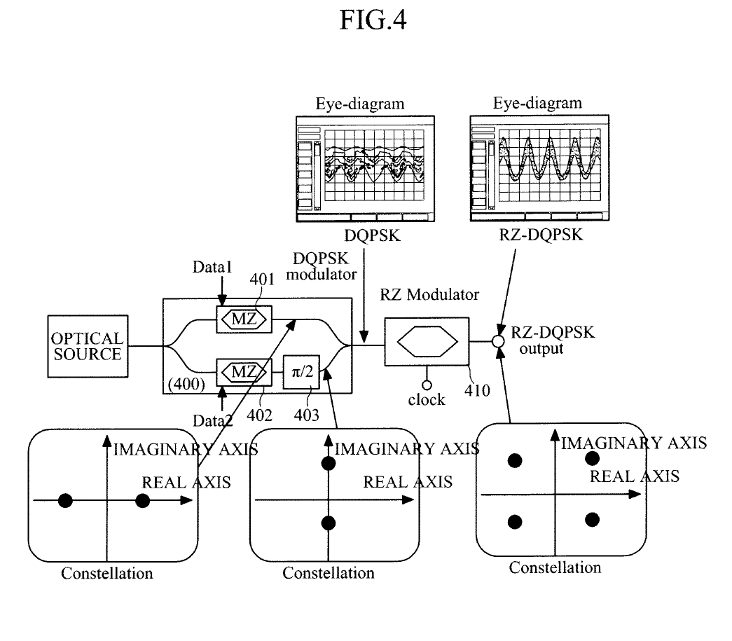

FIG. 4 illustrates a configuration of a conventional Return-to-Zero Differential Quadrature Phase Shift Keying (RZ-DQPSK) optical transmitting apparatus.

Referring to FIG. 4, the RZ-DQPSK optical transmitting apparatus includes a DQPSK modulator 400 and a RZ modulator 410. The DQPSK modulator 400 includes two MZ modulators 401 and 402 and a phase shifter 403 connected to any one of the MZ modulators 401 and 402. The MZ modulators 401 and 402 correspond to DPSK modulators. The output signal of the MZ modulator 402 is shifted by a phase of π/2 by the phase shifter 403, the shifted signal is added with the output signal from the MZ modulator 401, and then a DQPSK signal is output. A DQPSK eye-diagram of the resultant DQPSK signal is shown in FIG. 4. The DQPSK modulation ensures a transfer rate two times higher than that of DPSK modulation. In addition, is a data signal data1 applied to the MZ modulator 401 and a data signal data2 applied to the MZ modulator 402 have the same function as the data signal 111 shown in FIG. 1 and have different patterns generated by a precoder.

If a separate RZ modulator 410 is connected in series with the DQPSK modulator 400, a RZ-DQPSK eye-diagram shown in FIG. 4 can be obtained. In this case, the RZ-DQPSK optical transmitting apparatus is less influenced by the patterns of optical/electrical devices used to generate DPSK signals and the performance of the RZ-DQPSK optical transmitting apparatus can be maintained constant with lower SNR than that of DPSK signals. Consequently, the RZ-DQPSK output appears in the pattern of a sine-wave signal and has values of 0, π/2, π and 3π/2 on a phase plane. However, installation of a separate RZ modulator and synchronization of a DQPSK modulator with a RZ modulator are needed, which increases optical loss and makes the structure of the RZ-DQPSK optical transmitting apparatus complicated, resulting in an increase of manufacturing costs.

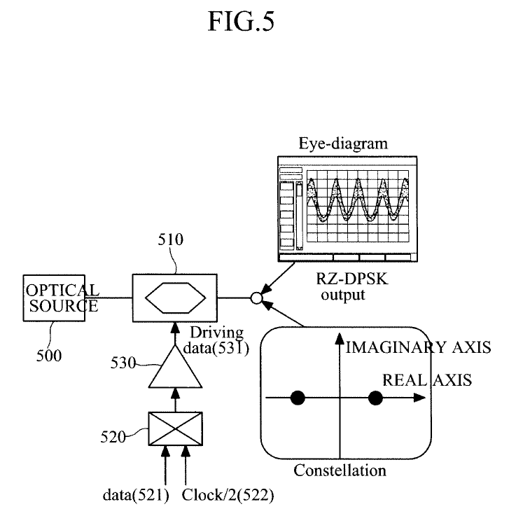

FIG. 5 illustrates a configuration of a RZ-DPSK optical transmitting apparatus according to an exemplary embodiment.

Referring to FIG. 5, the RZ-DPSK optical transmitting apparatus includes an optical source 500, a phase modulator 510 and a mixer 520.

The optical source 500, which outputs optical signals, may be a laser diode (LD). The phase modulator 510 modulates an optical signal received from the optical source 500. The phase modulator 510 may be a MZ modulator. The phase modulator 510 modulates a driving data signal output from the mixer 520, not data output from a precoder. Here, the mixer 520 receives data 521 output from the precoder and a clock signal 522 whose frequency is half the frequency of transfer of the data 521, mixes the data 521 with the clock signal 522 to create a driving data signal 531, and outputs the driving data signal 531 to the phase modulator 510.

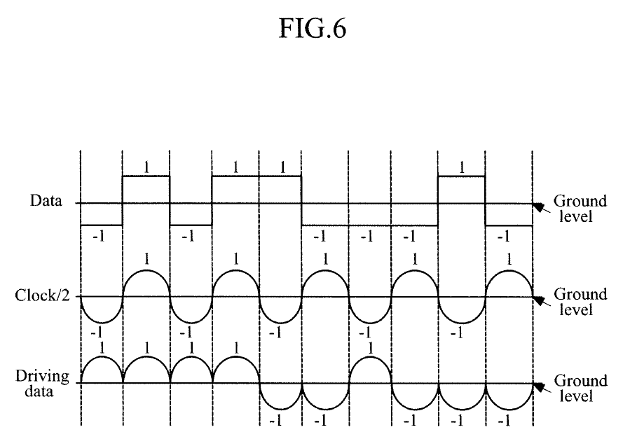

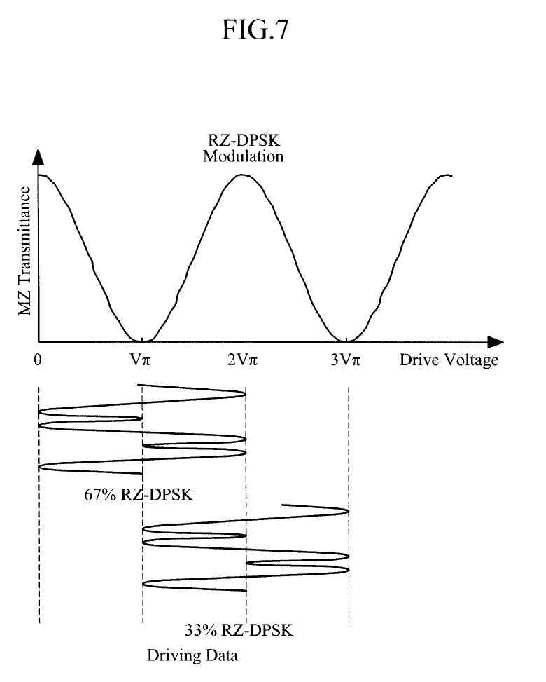

FIG. 6 is a view for explaining a method of generating the driving data signal 531 according to an exemplary embodiment, and FIG. 7 is a view for explaining a method of applying the driving data signal 531 according to an exemplary embodiment.

The driving data signal 531 is generated by applying data 521 driving signal output from the precoder and a clock signal 522 whose frequency is half the frequency of transfer of the data 521 to the mixer 520. The data 521 forms a pulse which varies between a positive value and a negative value with respective to a ground level, and the ½ frequency clock signal 522 is applied to the mixer 520 after synchronized with the data 521. Accordingly, the mixer 520 outputs a signal (that is, the driving data signal 531) corresponding to a multiplication of the data 521 and ½ frequency clock signal 522. In this case, a relationship between the data 521 and the driving data signal 531 can be expressed as in the following table 1. When the phase of the ½ frequency clock signal is flipped by 180 degrees, the phase of the driving data signal 531 is also flipped by 180 degrees.

TABLE 1

| Data | Driving Data |
|---|---|
| 1, −1 | 1, 1 |
| 1, 1 | 1, −1 |
| −1, −1 | −1, 1 |
| −1, 1 | −1, −1 |

That is, data ‘1, 1’ is reversed to ‘−1, −1’ and ‘1, −1’ is reversed to ‘−1, 1’. The driving data signal 531 is generated by placing a DC bias at the lowest or highest point on a transfer curve of a MZ modulator and applying a signal amplified to have a width of 2Vπ with respect to the DC bias to double the frequency of the signal. The driving data signal 531 has the same signal pattern as the RZ-DPSK illustrated in FIG. 5 and has values of 0 and π on the phase plane.

According to another exemplary embodiment, the RZ-DPSK optical transmitting to apparatus can further include an RF amplifier 530 to appropriately amplify the amplitude of an electrical signal. Conventionally, a wide-band amplifier is needed to amplify NRZ data for driving MZ modulators. However, in the current embodiment, since the output signal of the mixer 520 has the same pattern as a clock signal, required is an RF amplifier 530 which can only amplify at a ½ frequency of the frequency of transfer of data. Accordingly, use of a narrow-band RF amplifier is possible.

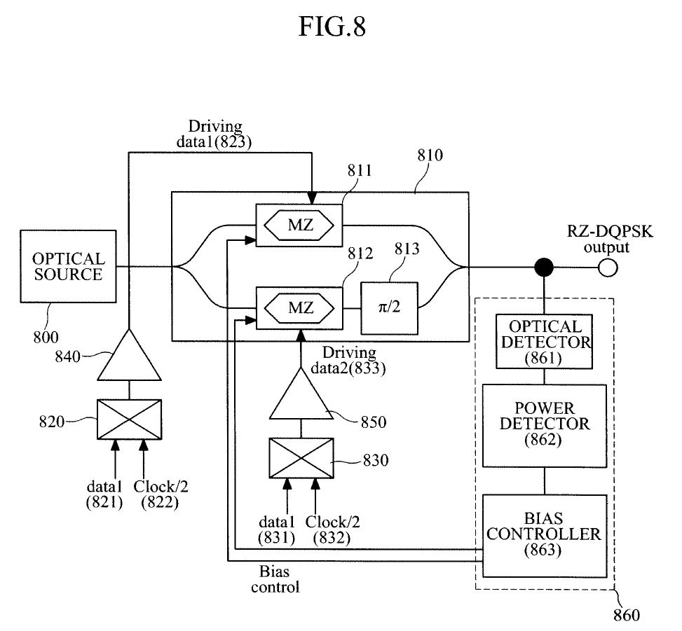

FIG. 8 illustrates a configuration of a RZ-DQPSK optical transmitting apparatus according to an exemplary embodiment.

Referring to FIG. 8, the RZ-DQPSK optical transmitting apparatus includes an optical source 800 and a phase modulator 810. The optical source 800, which outputs optical signals, may be a LD. The phase modulator 810 is a DQPSK modulator which includes a first phase modulator 811, a second phase modulator 812 connected in parallel with the first phase modulator 811, and a phase shifter 813 connected in series with an output terminal of the second phase modulator 812. According to an exemplary embodiment, the first and second phase modulator 811 and 812 may be MZ modulators. By disposing the MZ modulators in parallel and configuring them in a Mach-Zehnder interferometer type, a DQPSK modulator is constructed.

The first phase modulator 811 modulates a first driving data signal 823 output from a first mixer 820, not first data data1 output from a precoder. Likewise, the second phase modulator 812 modulates a second driving data signal 833 output from a second mixer 830, not second data to data2 output from the precoder. The phase shifter 813 shifts the phase of the output signal of the second phase shifter 812 by π/2. The phase-shifting is to generate a DQPSK signal.

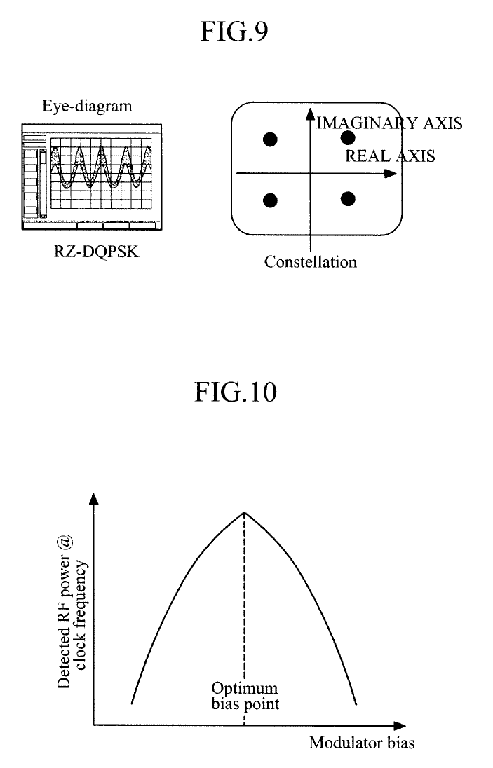

The first mixer 820 receives and mixes the first data 821 output from the precoder and a clock signal 822 whose frequency is half the frequency of transfer of the first data 821 and outputs the result of the mixing as a first driving data signal 823 to the first phase modulator 811. Likewise, the second mixer 830 receives and mixes second data 831 output from the precoder and a clock signal 832 whose frequency is half the frequency of transfer of the second data 831 and outputs the result of the mixing as a second driving data signal 833 to the second phase modulator 812. The first data 821 and the second data 831 have different patterns and the same transfer bit rate. A method of generating and applying the first driving data signal 823 and the second driving data signal 833 is the same as the method described above with reference to FIGS. 6 and 7. Consequently, a signal having a data pattern illustrated in FIG. 9 and values of 0, π/2, π and 3π/2 can be generated using a single MZ-DQPSK modulator.

Accordingly, according to another exemplary embodiment, the RZ-DQPSK optical transmitting apparatus further includes a first RF amplifier 840 and a second RF amplifier 850 to appropriately amplify the amplitude of an electrical signal. Conventionally, a wide-band amplifier is needed to amplify NRZ data for driving MZ modulators. However, in the current embodiment, since the output signals of the first and second mixers 820 and 830 have the same patterns as the clock signals 822 and 832, the first and second RF amplifiers 840 and 850 only amplify at a ½ frequency of the frequency of transfer of data. Accordingly, narrow-band RF amplifiers can be used.

According to another exemplary embodiment, the DQPSK optical transmitting apparatus further includes a bias controller 860. The bias controller 860 includes an optical detector 861, an RF power detector 862 and a bias controller 863. The optical detector 861 detects an optical signal split from the output of the phase modulator 810 and converts the optical signal into an to electrical signal. The optical detector 861 may be a photodiode. An RF power detector 862 detects an RF power value of the output optical signal, and a bias controller 863 adjusts a bias according to the RF power value.

The pattern of a RZ-DQPSK signal, as illustrated in FIG. 9, has a sine-wave form whose frequency is the same as a transfer bit rate. An RF power of the RZ-DQPSK signal, as illustrated in FIG. 10, is maximized at an optimal bias value and is reduced when the characteristics of a transfer curve of an optical modulator change due to external factors. Accordingly, the bias controller 860 feeds back bias of the first and second phase modulators 811 and 812 such that the amplitude of a clock frequency to be detected is maximized, thereby optimizing the characteristics of the RZ-DQPSK optical transmitting apparatus.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. An optical transmitting apparatus outputting a signal having the same phase characteristics as a Return-to-Zero Differential Phase-Shift-Keying (RZ-DPSK) signal by using a single phase modulator.

2. The optical transmitting apparatus of claim 1, further comprising:
a mixer to output a driving data signal by receiving a data signal from a precoder and a clock signal having a frequency which is half a frequency of the data signal and mixing the data signal with the clock signal; and
a phase modulator to modulate an optical signal output from an optical source using the driving data signal.

3. The optical transmitting apparatus of claim 2, wherein the phase modulator is a Mach-Zehnder modulator.

4. The optical transmitting apparatus of claim 2, wherein the clock signal is input to the mixer after being electrically synchronized with the data signal.

5. The optical transmitting apparatus of claim 2, wherein the driving data signal is obtained by multiplexing the data signal with the clock signal.

6. The optical transmitting apparatus of claim 2, further comprising an RF amplifier to amplify the driving data signal output from the mixer and output the amplified driving signal to the phase modulator.

7. The optical transmitting apparatus of claim 6, wherein the RF amplifier is a narrow-band RF amplifier which amplifies only a frequency which is half the frequency of the data signal.

8. An optical transmitting apparatus outputting a signal having the same phase characteristics as a Return-to-Zero Differential Quadrature Phase-Shift-Keying (RZ-DQPSK) signal by using two phase modulators connected in parallel.

9. The optical transmitting apparatus of claim 8, comprising:
a first mixer to output a first driving data signal by mixing a first data signal generated by a precoder with a clock signal having a frequency which is half a frequency of the first data signal;
a second mixer to output a second driving data signal by mixing a second data signal is generated by the precoder with a clock signal having a frequency which is half a frequency of the second data signal; and
a phase modulator including a first phase modulator to modulate an optical signal of an optical source using the first driving data signal output from the first mixer, and a second phase modulator to modulate an optical signal of the optical source using the second driving data signal output from the second mixer.

10. The optical transmitting apparatus of claim 9, wherein the first and second phase modulators are Mach-Zehnder modulators.

11. The optical transmitting apparatus of claim 9, wherein the clock signal input to the first mixer is transferred to the first mixer after being electrically synchronized with the first data signal, and the clock signal input to the second mixer is transferred to the second mixer after being electrically synchronized with the second data signal.

12. The optical transmitting apparatus of claim 9, further comprising:
a first RF amplifier to amplify the first driving data signal output from the first mixer and output the amplified first driving data signal to the first phase modulator; and
a second RF amplifier to amplify the second driving data signal output from the second mixer and output the amplified second driving data signal to the second phase modulator.

13. The optical transmitting apparatus of claim 12, wherein each of the first RF amplifier and the second RF amplifier is a narrow-band RF amplifier which amplifies at only a frequency which is half a frequency of a corresponding one of the first and second data signals.

14. The optical transmitting apparatus of claim 9, further comprising a bias controller to adjust a bias of the first phase modulator and the second phase modulator by detecting an output of the phase modulator.

15. The optical transmitting apparatus of claim 14, wherein the bias controller comprises:
an optical detector to convert an optical signal output from the phase modulator into an electrical signal;
an RF power detector to detect RF power of the electrical signal; and
a bias controller to adjust the bias of the first phase modulator and the second phase modulator based on the RF power.
